(19) United States
(12) Patent Application Publication
(10) Pub. No.: US 2007/0134394 A1
(43) Pub. Date: Jun. 14, 2007

(54) Method of manufacturing particulate ice cream for storage in conventional freezers

(75) Inventor: Stan Jones, Vienna, IL (US)

Correspondence Address: STOCKWELL & SMEDLEY, PSC, 861 CORPORATE DRIVE, SUITE 200, LEXINGTON, KY, 40503, US

(73) Assignee: Dippin' Dots, Inc.

(21) Appl. No.: 11/299,921

(22) Filed: Dec. 12, 2005

(51) Int. Cl. A23G 9/00

(52) U.S. Cl. 426/565

(57) ABSTRACT

An apparatus and method for making particulate ice cream with a freezing point sufficient for use within a typical retail grocery or home freezing environment is disclosed.

### CROSS-REFERENCE TO RELATED APPLICATIONS

This application claims priority to PCT/US2004/032855, filed Oct. 7, 2004, which in turn claims priority to U.S. Provisional Application No. 60/509,349, filed Oct. 7, 2003.

### FIELD OF THE INVENTION

The present invention relates to particulate ice cream, and more particularly to an apparatus and method for manufacturing particulate ice cream having a melting point sufficient for storage within conventional dairy freezers and storage equipment.

### BACKGROUND OF THE INVENTION

Recent developments in cryogenics have enabled the manufacture of ice cream in particulate form using cryogenic equipment. One such method for manufacturing ice cream is described in detail in U.S. Pat. No. 5,126,156, which is hereby incorporated by reference. Storing particulate ice cream made using cryogenic techniques sometimes requires that specialized equipment must be used. This is because some particulate ice creams require storage temperatures which cannot rise above −35° F. For immediate consumption, some particulate ice creams can be stored in freezers which do not rise above −20° F. and still not lose their free flowing properties. However, long-term storage at this temperature is not practicable as the product would eventually clump together and no longer be free-flowing.

Unfortunately, conventional freezers in typical grocery dairy display freezers range in temperature between −10° F. and +0° F., and also have an additional albeit temporary rise of 10° F. during a one-hour defrost cycle (exact times and temperatures can vary). Thus, conventional grocery dairy freezers can be at +10° F. for as long as one hour. Even worse, some grocery dairy freezers do not always operate at optimum conditions, are leaking or are in need of repair in some way, so that they may reach temperatures as high as +15° F. for short periods. Home freezers are more stable and usually range between 0° F. and +5° F. They have a defrost cycle but it usually does not affect the interior temperature. In either case, particulate ice cream made using traditional methods cannot withstand such temperatures without clumping or outright melting. Consequently, a method of manufacturing particulate ice cream which can be stored in typical retail dairy case environments is desired.

### BRIEF DESCRIPTION OF THE DRAWINGS

FIG. 1 is a cross-sectional elevational view of the present invention;

FIG. 2A shows a sucrose molecule;

FIG. 2B shows a sucralose molecule;

FIG. 3 shows a erythritol molecule; and

FIG. 4 shows a xylitol molecule.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

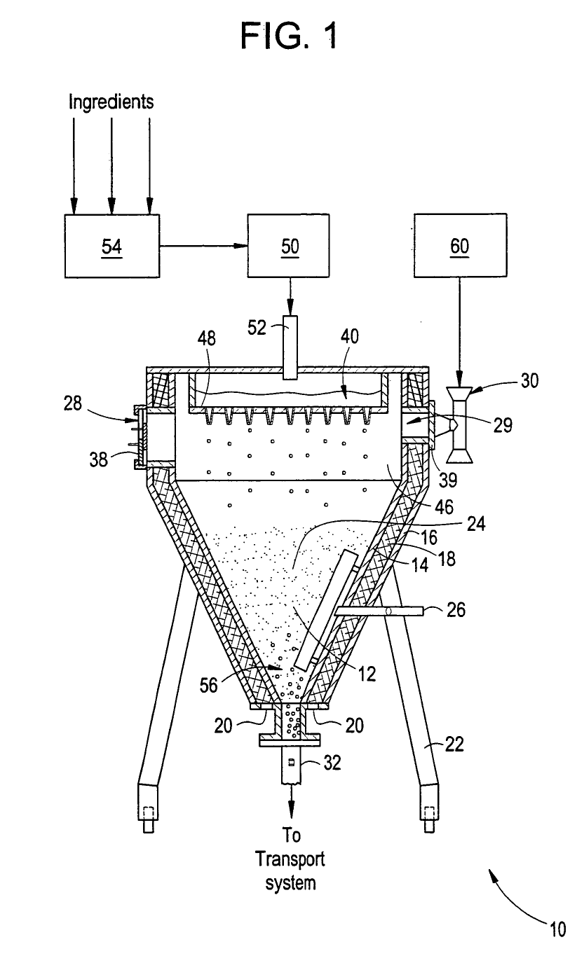

FIG. 1 shows a cryogenic processor constructed in accordance with the preferred embodiment of the present invention to produce free-flowing beads 56. A cryogenic processor 10 includes a freezing chamber 12 that is most preferably in the form of a conical tank that holds a liquid refrigerant therein. A freezing chamber 12 incorporates an inner shell 14 and an outer shell 16. Insulation 18 is disposed between the inner shell 14 and outer shell 16 in order to increase the thermal efficiency of the chamber 12. Vents 20 are also provided to ventilate the insulated area formed between the shells 14 and 16. The freezing chamber 12, as shown in FIG. 1, is a free-standing unit supported by legs 22.

Refrigerant 24, preferably liquid nitrogen, enters the freezing chamber 12 by means of refrigerant inlet 26. The refrigerant 24 is introduced into a chamber 12 through inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen beads 56 occurs through product outlet 32 adapted at the base of the freezing chamber 12.

An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives liquid composition from a delivery source 50. Typically, a pump (not shown) drives the liquid composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48.

In order to create uniformly sized beads 56 of frozen product, uniformly sized droplets 58 of liquid composition are required to be fed through gas diffusion chamber 46 to freezing chamber 12. The feed tray 48 is designed with feed assembly 40 that forms droplets 58 of the desired character. The frozen product takes the form of beads that are formed when the droplets 58 of liquid composition contact the refrigerant vapor in the gas diffusion chamber 46, and subsequently the liquid refrigerant 24 in the freezing chamber 12. After the beads 56 are formed, they fall to the bottom of chamber 12. A transport system connects to the bottom of chamber 12 at outlet 32 to auger or carry the beads 56 to a packaging and distribution network for later delivery and consumption. After having reached the outlet 32, the beads 56 are entirely free-flowing and do not stick together.

The vacuum assembly 30 cooperates with air inlet 28 and adjustment doors 38 so that ambient air flows through the inlet and around feed assembly 40 to ensure that no liquid composition freezes therein. This is accomplished by mounting the vacuum assembly 30 and air inlet 28 on opposing sides of the gas diffusion chamber 46 such that the incoming ambient air drawn by the vacuum assembly 30 is aligned with the feed assembly. In this configuration, ambient air flows around the feed assembly warming it to a sufficient temperature to inhibit the formation of frozen liquid composition in the feed assembly flow channels. An air source 60, typically in the form of an air compressor, is attached to vacuum assembly 30 to provide appropriate suction to create the ambient air flow required.

As stated, it is a goal of the present invention to increase the freezing point of the beads 56 of the present invention. This is because it is a commercial advantage of the present invention that the beads 56 can be stored either in a home freezer or in a conventional grocery dairy freezer, which as stated ranges in temperature between −10° F. and +0° F. with an occasional rise to +10° F. One way to accomplish this is to reduce the freeze point depression of the liquid composition that forms the beads 56, although the present invention should not be considered as limited thereto.

Most ice creams are composed of a mixture of air, water, milkfat, nonfat milk solids (NMS), sweeteners, stabilizers, emulsifiers, and flavors. As stipulated by the United States Department of Agriculture (USDA), ice cream is produced by freezing, while stirring, a pasteurized ice cream mix containing at least 10% milkfat and 20% total milk solids (TMS). The finished ice cream product must weight at least 4.5 lb/gal and must contain at least 1.6 lb of food solids or total solids (TS) per gallon, while a minimum total food solids must be 35.6%. It is impermissible to fall below these limits, or if one does then the finished product cannot be labeled ice cream.

The freezing point of the ice cream mix of the present invention which forms the beads 56 can be increased by making adjustments to one or more of the above components, and some adjustments work better in combination with each other. The first component is non-milk solids (NMS) content, the second is the stabilizers, the third is the emulsifiers, the fourth is the total solid (TS) content, and the fifth and perhaps most complex is the sweetener content.

Non Milk Solids (NMS)

NMS or serum solids enhance the texture of ice cream, aid in giving body and chew resistance, and may be less expensive than milkfat. However, milkfat may be substituted for NMS, but under USA federal government requirements only up to 14%. Whey solids, including modified whey products, may also be substituted for NMS but under USA federal government requirements not for more than 25% of the total NMS in the entire mix.

Egg yolk solids can also be used as NMS within the present invention. Egg yolk solids impart a delicate flavor, and also improve the body and texture of the resulting ice cream. Egg yolk solids also improve fat structure formation, presumably due to lecithin existing in a lecithin-protein complex, which can act similarly to an emulsifier. Egg yolk solids have almost no effect on freeze point depression, are high in food value, but unfortunately can increase the cost of the mix.

Dry whey solids can also be used as NMS within the ice cream mix of the present invention, because they are relatively inexpensive. Whey is the watery part of milk and contains most of the milk sugar in milk. As stated, federal standards in the USA permit substitution of whey solids for up to 25% of the NMS. However, unprocessed whey can cause a lower freezing point and potential for a sandy, grainy feel to the finished ice cream product. To address this, an increasing number of whey products are available that are processed to have high protein, reduced lactose contents, and a higher molecular weight. This higher molecular weight in turn means these processed whey products reduce the freeze point depression of the overall mix.

One means to process whey to have more desired characteristics is through a process known as ultrafiltration, in which a whey solution is repeatedly passed through a membrane that filters out components with a high molecular weight, such as high-protein whey, while passing components with a low molecular weight, such as water, salts, and lactose. This process results in a products known as whey protein concentrates (WPCs).

Stabilizers

The primary purposes for using stabilizers in the ice cream of the present invention are to increase mix viscosity, to stabilize the mix to prevent wheying off or separating, to retard or reduce ice and lactose crystal growth during storage especially during periods of temperature fluctuation also known as heat shock, to slow down moisture migration from the product to the package or the air, to provide uniformity to the product and resist melting, and to provide smoothness in texture during consumption. Retarding ice crystal growth is especially valuable because smaller ice crystals within the beads 56 result in a better taste and mouthfeel of the resulting ice cream product.

The stabilizers of the present invention must also have a clean, neutral flavor, and not bind to the intended ice cream flavors. Although stabilizers have little or no impact on the size of ice crystals at time of initial freezing, they do limit the rate of growth of ice crystals during recrystallization (where thawing and then re-freezing occurs). This could be due to a range of factors, including surface adsorption to the ice crystal itself, modifying the rate at which water can diffuse to the surface of a growing ice crystal during temperature fluctuations, and modifying the rate at which solutes and macromolecules can diffuse away from the surface of a growing ice crystal.

Additionally, many fish, insects, bacteria, and plants have the ability to tolerate or avoid freezing in their natural environments by secreting groups of proteins that have the ability to depress their freezing point (anti-freeze proteins), and/or resist the rate of ice recrystallization (ice structuring proteins or ISPs). When an ISP is introduced into an ice cream mix as a stabilizer or to act in support of a stabilizer, the ISP adsorbs to the surface of an ice crystal, thus blocking further growth of ice at that crystal surface. ISPs are desired where a stabilizer is not sufficiently effective or is undesirable in formulation.

In the ice cream mixes of the present invention, another type of stabilizer used is carrageenans, which act as a secondary hydrocolloid to prevent wheying off or separating of the ice cream mix, an undesired condition caused by the incompatibility of other stabilizers. At typical use levels, cartageenan contributes very little to viscosity in hot ice cream mixes which are heated as part of the pasteurization process referred to earlier. However, as the ice cream mixes cool, the stabilizer carrageenan undergoes a conformational change from a coil to a helix, at around 40° C. The helical forms produce structures that increase viscosity and create a weak gel that is easily broken by shear forces. This gel is capable of holding dispersed particles in suspension, and as it cools can help stabilize casein micelles to prevent further-phase separation. This improves resistance to separation of protein and polysacchararide rich phases in ice cream mixes, thereby improving resistance to melting of the resulting ice cream.

Stabilizers, among other functions, are also responsible for absorbing free water sometimes present within the ice cream mix. Stabilizing agents are also used to give texture, body, stiffness and alter the melting properties of ice cream. These are especially important in particulate ice cream such as that of the present invention, because forming the beads 56 in a spherical shape and the resulting free-flowing properties generated therefrom is critical to commercial success. The stabilizers accomplish this by binding up any free water that has not already frozen, and preventing that free water from freezing into large undesirable crystal sizes more often found in conventional ice cream, or in ice cream that has been in the freezer too long.

Emulsifiers

Emulsifiers are usually integrated with stabilizers within the ice cream mix of the present invention, although they perform a very different function from stabilizers. Emulsifiers are used to produce a stable suspension of two liquids that do not mix naturally. In ice cream, the two liquids would be a fatty solution and water. The colloidal structure of ice cream begins with the mix as a simple emulsion, with a discrete phase of partially crystalline fat globules surrounded by an interfacial layer comprised of proteins and surfactants, and also water. To keep these ingredients stably suspended, an emulsifier is used. The emulsifiers lower the fat/water interfacial tension in the ice cream mix, resulting in protein displacement from the fat globule surface, which in turn reduces the stability of the fat globule thereby allowing partial coalescence of that fat globule during the freezing process of the bead 56. This partial coalescence leads to the formation of a structure of the fat that beneficially contributes to texture and melting properties within the finished ice cream product. The texture of ice cream is an important quality attribute, because texture is the sensory manifestation of structure.

During the freezing stage, another dispersed phase of ice crystals are formed within the emulsion of ice cream mix. Air bubbles and ice crystals usually range in size from 20 μM to 50 μM and are surrounded by a temperature-dependent unfrozen phase. In addition, as stated the partially crystalline fat phase undergoes partial coalescence during the freezing process, resulting in a network of agglomerated fat bodies which partially surround the air bubbles, thus giving rise to a somewhat solid-like structure. Emulsifiers can include both mono- and di-glycerides, although within the present invention diglycerides are preferred because of their higher atomic weight. The concept of glycerides will be discussed in more detail infra, but suffice for now to say that glycerides are often associated with sweeteners. Thus, depending on the type of sweetener used, a sweetener can also act as an emulsifier.

Freezing Point in General

To understand the next parameter, total solids (TS), it is necessary to specifically describe the freezing process. The freezing point of ice cream is dependent on the concentration of the soluble constituents therein. The amounts of sweetener solids and lactose concentration can affect the freezing point of any ice cream mix. However, when latent heat is removed from water and ice crystals are formed, a new freezing point is established for the remaining solution, since it has become more concentrated in respect to the soluble constituents. As more and more water is turned into ice, the remaining fluid phase becomes increasingly viscous, because ice is essentially pure water that other molecules get excluded from during formation of ice crystals. Consequently, the freezing point of the unfrozen phase of the ice cream mix is lowered.

In freezing ice cream, the freezing point is being continuously lowered by crystallization of water and concentration of solutes (called freeze concentration), so that the temperature of the mix continues to drop, but drops at a slower rate. Thus, the refrigerant 24 referred to above (FIG. 1) must remove both latent heat of fusion due to crystallization, but also the sensible heat necessary to lower the temperature of the ice crystal slurry.

When the concentration of dissolved substances increases to a point where only about 18-20% of the original water remains unfrozen, the freezing point of the mix reaches a temperature at which no more ice can be formed. This point is often called the glass transition temperature. Within this state, the water in the ice cream can never be completely frozen, even at very low temperatures. At normal manufacturing and storage temperatures, a significant portion of the water remains in the liquid state, a factor that favorably influences the stability of ice cream. Introduction of ISPs can help dictate when an ice cream mix reaches the glass state.

Nonetheless, formation of the correct amount of ice during freezing is not sufficient to guarantee a high quality ice cream. The average size and distribution of sizes of ice crystals has a significant impact on smoothness and eating quality of ice cream. The freezing operation of the present invention intentionally produces mostly small crystals to yield an ice cream with a smooth mouthfeel. This is partly due to the rapidity at which the ice cream droplets 58 are frozen into beads 56. Because the freezing process is very rapid, taking perhaps two minutes at most, the ice crystals form much more quickly and are much smaller. Many other factors mentioned herein also lead to formation of smaller ice crystals within the beads 56,

Although many factors influence the mouthfeel of ice cream, it is generally understood that the majority of ice crystals should be smaller than 50 uM in size, and hopefully around 20 uM. If many crystals are larger than this, the ice cream will be perceived as coarse or icy.

Total Solids (TS)

Total solids (TS) replace water in the ice cream mix, thereby increasing the nutrititive value and mix viscosity and improving the body and texture. Egg yolk solids, for example, can reduce the freezing time of the resulting ice cream. Increasing the percentage of total solids decreases the percentage of frozen water in the resulting ice cream, which improves taste and texture. In frozen ice cream, water is present both as a liquid and as a solid, as not all water freezes due to the effect of the added solutes on the freezing point depression. The solid/liquid ratio affects the firmness of the ice cream.

Sweeteners

It is known that sugars do not dissociate in solution, so that the freezing point of solutions contain various sugars can be accurately computed from their concentration and molecular weight. Many ice cream mixes use sucrose as a sweetener, which has a freeze point depression of 2.5° F. This freeze point depression can be decreased by substituting sucralose for sucrose, potentially in combination with other sugars or sweeteners. Such a substitution can increase the freezing point (decrease the freeze point depression).

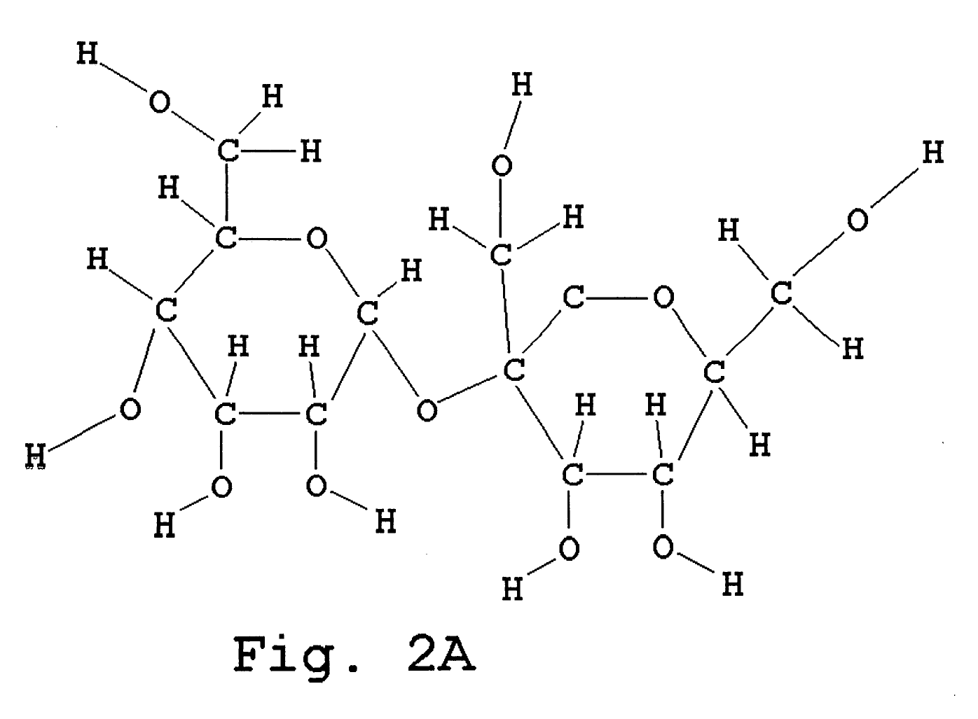

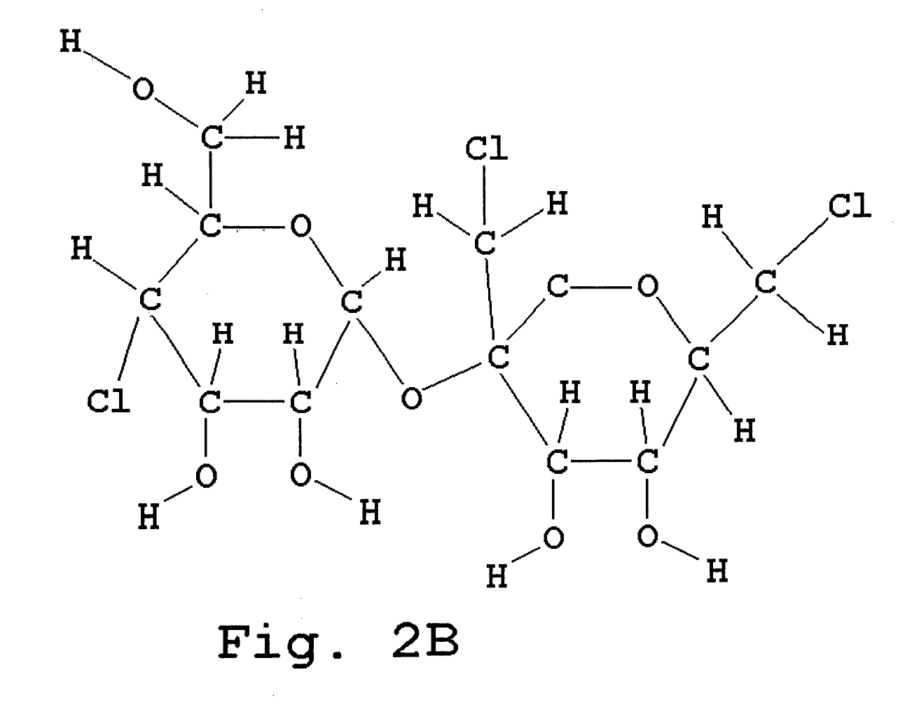

Sucralose is made by converting sugar to a no calorie, non-carbohydrate sweetener. As shown in FIGS. 2A and 2B, this conversion process selectively replaces three hydrogen-oxygen (hydrox) groups on the sucrose molecule with three chlorine atoms. This converts the sucrose (FIG. 2A) within sugar to sucralose (FIG. 2B), which is essentially inert and has a higher molecular weight than sucrose. This is because the atomic weight of a hydrox group is approximately 17, while the atomic weight of chlorine is approximately 35.3, thereby making a difference of approximately 18.3 atomic units. Multiplying this difference times three means there exists a significant difference in the molecular weight of sucralose and sucrose. The result is a stable sweetener that tastes like sugar, but because of its higher molecular weight has a lower freeze point depression than sucrose.

After consumption, sucralose passes through the body without being broken down for energy so it has no calories. Sucralose is consider 600 times sweeter than sugar, and remains stable during pasteurization treatment, which can raise the temperature of the ice cream mix to 40° C. However, because sucralose is so much sweeter than sucrose, unlike sucrose it is difficult to also use sucralose as a NFS or TS. This is because the volume of sucralose needed to achieve a specific sweetness is several magnitudes less than the sucrose. Thus, any attempt to use sucralose in bulk volumes would make the resulting ice cream mix excessively sweet.

Although sucralose is made from sugar, the body does not recognize it as sugar or a carbohydrate. Also, sucralose is not metabolized by the body, so it is calorie-free, and does not affect blood glucose levels. Sucralose also has no effect on carbohydrate metabolism or insulin secretion.

There exists a group of sugar alcohols, known as polyols. These polyols are somewhat of a hybrid between sugar and alcohol. Polyols include among others erythritol, xylitol, and maltitol. Inclusion of these specific sugar alcohols in an ice cream mix results in a much lower glycemic index, which is suitable for diabetics. However, besides being appropriate as sweeteners, these sugar alcohols can also function as bodying/bulking agents or NMS, and can also act as ice crystallization inhibitors. Also, polyols do not contribute to tooth decay. This is because polyols are resistant to metabolism by oral bacteria which break down sugars and starches to produce the specific acids which can lead to tooth enamel loss and cavity formation. Polyols are, therefore, non-cariogenic.

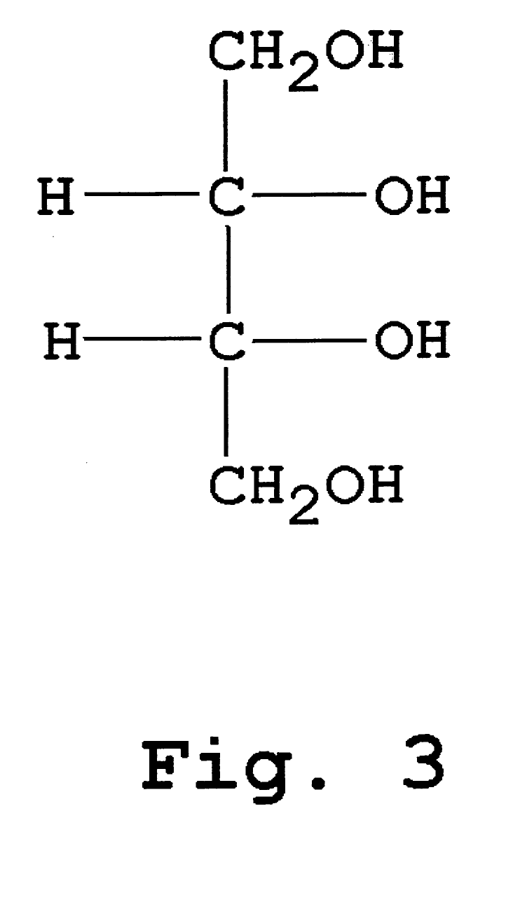

One polyol that is useful within the present invention as a sweetener is erythritol, which has excellent heat stability. Erythritol does not decompose even at temperatures as high at 160° C. This is an advantage during the pasteurization process which is a necessary step in preparation of the ice cream mix. However, being a monosaccharide, as shown in FIG. 3, erythritol has a lower molecular weight than sucrose, and has only four carbon atoms.

Erythritol is also safe for people with diabetes. Single dose and 14-day clinical studies demonstrate erythritol does not affect blood serum glucose or insulin levels. Clinical studies conducted in people with diabetes conclude that erythritol may be safely used to replace sucrose in foods formulated specifically for people with diabetes.

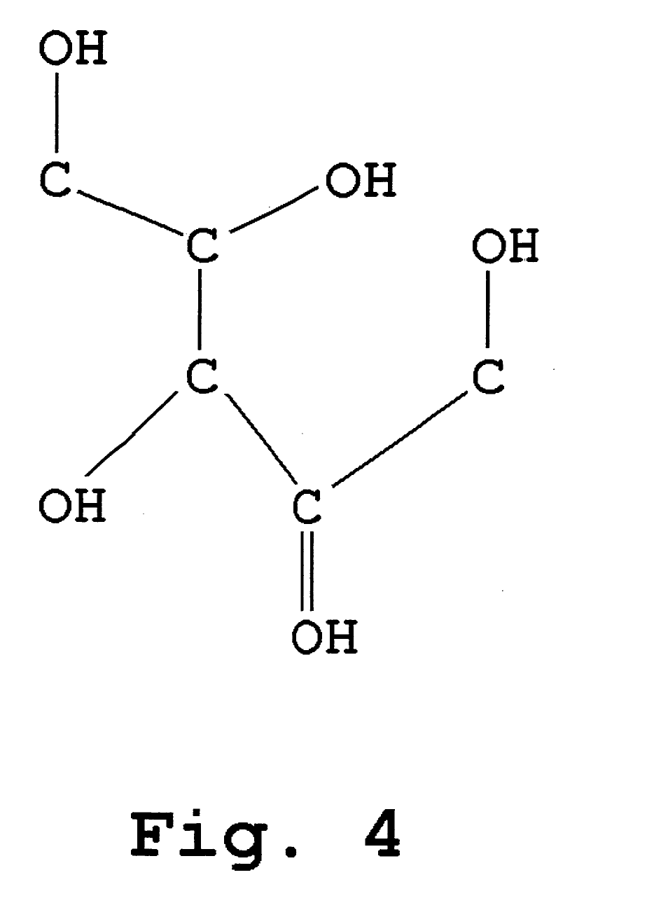

Another polyol used as a sweetener within the present invention is xylitol, which as shown in FIG. 4 has five carbon atoms rather than six. Xylitol's five-carbon molecule has strong chemical bonds that are very difficult for oral bacteria to digest. Thus, when foods containing xylitol are consumed, these oral bacteria populations starve out and decline. Accordingly, foods containing xylitol cause less tooth decay.

Another polyol used in the present invention is maltitol. Maltitol is also known as hydrogenated maltose, a disaccharide with a molecular weight comparable to sucrose.

Polydextrose is a low-calorie bulking agent that can be used at significant concentration without affecting viscosity, yet because of its high molecular weight has a freezing point depression significantly smaller than sucrose.

Dextrose, being a monosaccharide, causes greater freezing point depression than sucrose, maltose, or lactose, which are disaccharides. However, in small proportions, dextrose can also be used as an ingredient within the ice cream mix of the present invention without noticeably affecting the freezing point. Finally, aspartame, acesulfame K, neotame, and saccharin can also be used as sweeteners within the present invention. Neotame is particularly advantageous because it has a much higher molecular weight (C20 H30 N2 O5) than sucrose.

The various aspects of the present invention has been described in detail with particular reference to preferred embodiments thereof, but it will be understood that variations and modifications can be effected within the spirit and scope of the invention as described herein. It is anticipated that various changes may be made in the arrangement and operation of the system of the present invention without departing from the spirit and scope of the invention, as depicted in the following claims.

What is claimed is:

1. A method of manufacturing particulate ice cream, comprising:
formulating an ice cream mix comprising air, water, milkfat, nonfat milk solids, sweeteners, stabilizers, emulsifiers, and flavors;
dripping said mix into a cryogenic apparatus;
freezing portions of said mix into beads;
augering said beads out of said cryogenic apparatus; and
storing said beads in a freezer ranging in temperature from −10° F. to 0° F. so that said beads do not melt and do not lose their free-flowing characteristics.

2. The method of claim 1, wherein said mix is dripped in the form of uniformly sized droplets.

3. The method of claim 1, further comprising:
freezing portions of said mix into uniformly sized beads;

4. The method of claim 1, wherein said freezer has a temporary defrost cycle which causes said freezer to reach a temperature of +10° F. for a short time.

5. The method of claim 1, wherein said freezer is a home freezer and does not rise above 5° F.

6. The method of claim 1, further comprising:
including egg yolk solids as non milk solids.

7. The method of claim 1, further comprising:
including dry whey solids as non milk solids.

8. The method of claim 7, further comprising:
processing said dry whey solids to have high protein, reduced lactose contents, and a higher molecular weight.

9. The method of claim 8, wherein said processing step includes an ultrafiltration step, comprising:
repeatedly passing a whey solution through a membrane, thereby
retaining components with a high molecular weight, such as high-protein whey, while simultaneously
filtering out components with a low molecular weight.

10. The method of claim 1, wherein said stabilizers perform the following steps:
increasing mix viscosity;
preventing wheying off or separating of the mix;
retarding or reducing ice and lactose crystal growth during said storage step, including during periods of temperature fluctuation;
slowing down moisture migration from the beads to a package or to air;
providing uniformity to the product;
resisting melting, and
providing smoothness in texture during consumption.

11. The method of claim 10, further comprising:
limiting the rate of growth of ice crystals during recrystallization.

12. The method of claim 11, further comprising:
modifying the rate at which water can diffuse to the surface of a growing ice crystal during said temperature fluctuations; and
modifying the rate at which solutes and macromolecules can diffuse away from the surface of a growing ice crystal.

13. The method of claim 1, further comprising:
including anti-freeze proteins to act in conjunction with said stabilizers.

14. The method of claim 1, further comprising:
including ice structuring proteins to act in conjunction with said stabilizers.

15. The method of claim 14, wherein said ice structuring proteins performing the following steps:
adsorbing to the surface of an ice crystal, thereby
blocking further growth of ice at the surface of said crystal.

16. The method of claim 10, further comprising:
binding up any free water that has not already frozen.

16. The method of claim 1, further comprising:
including carrageenans within said stabilizers, wherein said carrageenans act as a secondary hydrocolloid, thereby
stabilizing casein micelles within said ice cream mix, thereby
preventing phase separation of said ice cream mix.

17. The method of claim 1, wherein said emulsifier performs the following steps:
stably suspending a discrete phase of partially crystalline fat globules surrounded by an interfacial layer comprised of proteins and surfactants and water within said ice cream mix.

18. The method of claim 17, further comprising:
lowering the fat/water interfacial tension in said ice cream mix, thereby resulting in protein displacement from the fat globule surface;
reducing the stability of the fat globule; thereby
allowing partial coalescence of that fat globule.

19. The method of claim 18, further comprising:
forming a dispersed phase of ice crystals within the emulsion of ice cream mix, so that air bubbles and ice crystals ranging in size from 20 μM to 50 μM and are surrounded by a temperature-dependent unfrozen phase.

20. The method of claim 1, further comprising:
prior to said step of dripping, pasteurizing said ice cream mix.

21. The method of claim 1, wherein said sweeteners comprise sucralose.

22. The method of claim 1, wherein said sweeteners comprise erythritol.

23. The method of claim 1, wherein said sweeteners comprise maltitol.

24. The method of claim 1, wherein said sweeteners comprise polydextrose.

25. The method of claim 1, wherein said sweeteners comprise neotame.

26. The method of claim 1, wherein said sweeteners comprise aspartame.

27. The method of claim 1, wherein said sweeteners comprise saccharin.

28. The method of claim 1, wherein said sweeteners comprise compounds having a molecular weight higher than sucrose.

29. The method of claim 1, wherein said sweeteners comprise sugar alcohols.

30. The method of claim 29, wherein said sugar alcohols also function as bodying/bulking agents or NMS, and can also act as ice crystallization inhibitors.

31. The method of claim 29, further comprising:
selectively replacing three hydrogen-oxygen groups on the sucrose molecule with three chlorine atoms, thereby
increasing the molecular weight of the resulting sucralose and sucrose
